(19) United States
(12) Patent Application Publication
(10) Pub. No.: US 2025/0310438 A1
(43) Pub. Date: Oct. 2, 2025

(54) VOICE PROCESSING DEVICE, VOICE PROCESSING METHOD, AND COMPUTER-READABLE STORAGE MEDIUM

(71) Applicant: Panasonic Automotive Systems Co., Ltd., Kanagawa (JP)

(72) Inventors: Tomofumi YAMANASHI, Kanagawa (JP); Naoya MOCHIKI, Kanagawa (JP); Yutaka BANBA, Kanagawa (JP)

(21) Appl. No.: 19/065,433

(22) Filed: Feb. 27, 2025

(30) Foreign Application Priority Data
Mar. 28, 2024 (JP) 2024-052973

(51) Int. Cl. H04M 3/523; H04M 9/08

(52) U.S. Cl. CPC H04M 3/523; H04M 9/082; H04M 2201/41

(57) ABSTRACT

A voice processing device according to the present disclosure includes a memory in which a program is stored, and a processor coupled to the memory and configured to perform processing by executing the program. The processing includes processing voice signals input from a plurality of microphones; recognizing voices of utterers each present in corresponding one of areas, based on the voice signals; associating area information of each of the areas with utterer information of corresponding one of the utterers whose voice is recognized in corresponding one of the areas; and selectively switching a call area to a call area corresponding to a setting of a conversation mode, based on the utterer information. In the selectively switching, the call area is selected by selection of a voice signal from among the voice signals and selection of a speaker that outputs the voice signal from among a plurality of speakers.

### CROSS-REFERENCE TO RELATED APPLICATIONS

This application is based upon and claims the benefit of priority from Japanese Patent Application No. 2024-052973, filed on Mar. 28, 2024, the entire contents of which are incorporated herein by reference.

### FIELD

The present disclosure relates to a voice processing device, a voice processing method, and a computer-readable storage medium.

### BACKGROUND

Hitherto, there is an in-vehicle apparatus that turns on a speaker of a seat of a predetermined passenger in a hands-free call in a vehicle.

For example, JP 2021-034781 A discloses an in-vehicle apparatus that recognizes an image of a passenger of a vehicle, turns on a speaker of a seat space of the passenger associated with a call partner, and outputs a voice.

An object of the present disclosure is to provide a voice processing device, a voice processing method, and a computer-readable storage medium capable of setting a call area of an utterer corresponding to a conversation mode.

### SUMMARY

A voice processing device according to the present disclosure includes a memory and a processor. A program is stored in the memory. The processor is coupled to the memory and configured to perform processing by executing the program. The processing includes processing voice signals input from a plurality of microphones; recognizing voices of utterers each present in corresponding one of areas, based on the voice signals; associating area information of each of the areas with utterer information of corresponding one of the utterers whose voice is recognized in corresponding one of the areas; and selectively switching a call area to a call area corresponding to a setting of a conversation mode, based on the utterer information. In the selectively switching, the call area is selected by selection of a voice signal from among the voice signals and selection of a speaker that outputs the voice signal from among a plurality of speakers.

### BRIEF DESCRIPTION OF THE DRAWINGS

FIG. 1 is a diagram illustrating an example of a call model of a vehicle to which a voice processing device according to an embodiment is applied;

FIG. 2 is a diagram illustrating an example of processing blocks of voice processing in an in-vehicle device;

FIG. 3 is a diagram illustrating an example of a configuration of functional blocks for switching a call by a control unit;

FIG. 4 is a diagram illustrating an example of functional blocks of an SR that performs speaking person recognition;

FIG. 5 is a flowchart illustrating an example of speaking person registration processing in the in-vehicle device;

FIG. 6 is a flowchart illustrating an example of speaking person recognition processing executed in a speaking person recognition mode by the SR of the in-vehicle device;

FIG. 7 is a flowchart illustrating an example of control processing in a voice system;

FIG. 8 is a view illustrating an example of a setting unit for a conversation mode;

FIG. 9 is a view illustrating an example of a seat pattern selected according to the conversation mode;

FIG. 10 is a diagram illustrating an example of processing blocks of a voice processing device according to a first modified example of the embodiment;

FIG. 11 is a diagram for describing an operation of an ICC;

FIG. 12 is a flowchart illustrating an example of control processing in a voice system; and

FIG. 13 is a diagram illustrating an example of a configuration of hardware blocks of a voice processing device according to a third modified example of the embodiment.

### DETAILED DESCRIPTION

Hereinafter, embodiments of a voice processing device, a voice processing method, and a computer-readable storage medium according to the present disclosure will be described in detail with reference to the accompanying drawings.

### Embodiment

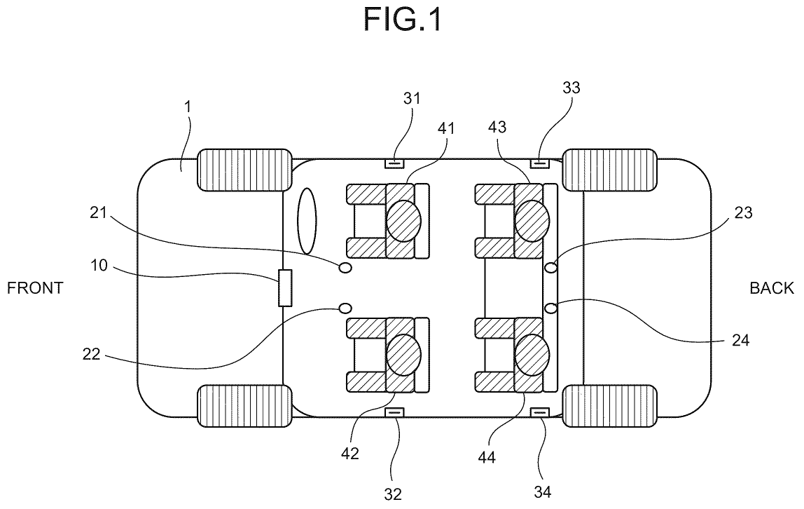

FIG. 1 is a diagram illustrating an example of a call model of a vehicle to which a voice processing device according to an embodiment is applied. In a plan view of a vehicle 1 illustrated in FIG. 1, an arrangement of seats and an arrangement of a voice system are illustrated. A schematic configuration of the vehicle 1 that includes a steering wheel and four wheels is illustrated.

The vehicle 1 in FIG. 1 is, for example, a right-hand drive vehicle, and is a vehicle including a driver's seat and a passenger seat which are front-row seats (also referred to as front seats), and a row of back seats (also referred to as back seats). For the sake of explanation, FIG. 1 illustrates a total of four passengers, one for each of the driver's seat (seat 41) and the passenger seat (seat 42), and one for each of a seat 43 and a seat 44 among three back seats.

The number of passengers is not limited thereto. As for the number of passengers, there may be one driver, or there may be a plurality of passengers in a range with the maximum number of passengers of the vehicle 1 as an upper limit.

Furthermore, each of the seats (the seat 41, the seat 42, the seat 43, and the seat 44) illustrated in FIG. 1 corresponds to an “area” of an utterer. All the back seats may be set as one “area”, or more precisely, a space between the seats 43 and 44 may also be regarded as one seat and set as the “area”. Here, a description will be given while the area of the utterer is fixed to four areas of the seat 41, the seat 42, the seat 43, and the seat 44.

The vehicle 1 is equipped with an in-vehicle device 10, and microphones (a first microphone 21, a second microphone 22, a third microphone 23, and a fourth microphone 24) and speakers (a first speaker 31, a second speaker 32, a third speaker 33, and a fourth speaker 34) that are communicably connected to the in-vehicle device 10.

Here, the voice processing device according to the embodiment is applied to the in-vehicle device 10. The respective speakers correspond to a “plurality of voice signal output units”. The respective microphones correspond to a “plurality of voice signal input units”.

The first microphone 21 and the second microphone 22 are provided in a direction in which voices of speaking persons of the front seats are input. The first microphone 21 is provided in a direction in which the voice of the speaking person of the seat 41 (driver's seat) is directly input, and the second microphone 22 is provided in a direction in which the voice of the speaking person of the seat 42 (passenger seat) is directly input. As an example, the first microphone 21 and the second microphone 22 are mounted between the seat 41 (driver's seat) and the seat 42 (passenger seat). The first microphone 21 may be mounted on a headrest of the seat 41 (driver's seat). The second microphone 22 may be mounted on a headrest of the seat 42 (passenger seat).

The third microphone 23 and the fourth microphone 24 are provided in a direction in which voices of speaking persons of the back seats are input. The third microphone 23 is provided in a direction in which the voice of the speaking person of the seat 43 is directly input, and the fourth microphone 24 is provided in a direction in which the voice of the speaking person of the seat 44 is directly input. As an example, the third microphone 23 and the fourth microphone 24 are mounted on a headrest or the like between the seat 43 and the seat 44.

The first speaker 31 is a speaker near the seat 41. The second speaker 32 is a speaker near the seat 42. The third speaker 33 is a speaker near the seat 43. The fourth speaker 34 is a speaker near the seat 44. Here, the speaker near the seat is a speaker corresponding to the seat.

The numbers and positions of the microphones and the speakers are merely examples, and are not limited to those illustrated in FIG. 1. The number of microphones and an arrangement of the microphones may be any number and any arrangement as long as the speaking person and the seat can be associated with each other by the microphone to which the voice is input. The speaker may be provided according to the number of back seats. For example, the speaker provided on the headrest or the like of the back seat may be associated with three people.

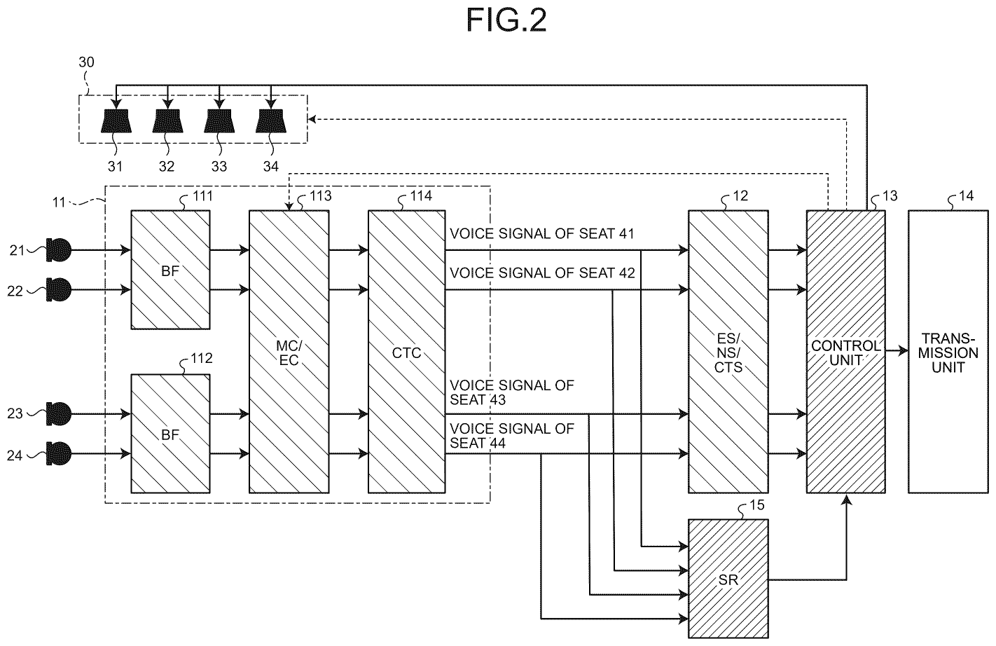

FIG. 2 is a diagram illustrating an example of processing blocks of voice processing in the in-vehicle device 10. The voice processing blocks illustrated in FIG. 2 include a voice signal input and processing unit 11, an ES/NS/CTS 12, a control unit 13, a transmission unit 14, and an SR 15. The voice signal input and processing unit 11 includes a first BF 111, a second BF 112, an MC/EC 113, and a CTC 114.

Here, the BF refers to a beam former. The MC/EC refers to a music canceller and an echo canceller. The CTC refers to a cross-talk canceller. The SR refers to a voice recognition unit that performs speaking person recognition. The ES refers to an echo suppressor. The NS refers to a noise suppressor. The CTS refers to a cross-talk suppressor.

The voice signal input and processing unit 11 executes processing of separating a voice signal of an utterer at each seat from an input signal input from each of the microphones (the first microphone 21, the second microphone 22, the third microphone 23, and the fourth microphone 24).

First, the first BF 111 and the second BF 112 enhance the voice signal of the utterer of each seat. The first BF 111 enhances the voice signal of the utterer of the seat 41 (driver's seat) from the input signal of the first microphone 21, enhances the voice signal of the utterer of the seat 42 (passenger seat) from the input signal of the second microphone 22, and outputs the voice signal of the utterer of the seat 41 (driver's seat) and the voice signal of the utterer of the seat 42 (passenger seat) in parallel.

In addition, the second BF 112 enhances the voice signal of the utterer of the seat 43 (back seat) from the input signal of the third microphone 23, enhances the voice signal of the utterer of the seat 44 (back seat) from the input signal of the fourth microphone 24, and outputs the voice signals of the utterers of the respective back seats in parallel.

The MC/EC 113 performs music cancellation and echo cancellation on each of the voice signals (the voice signal of the seat 41, the voice signal of the seat 42, the voice signal of the seat 43, and the voice signal of the seat 44) output in parallel from the first BF 111 and the second BF 112.

As the music canceller, the MC/EC 113 cancels an input component corresponding to a playback music being output to a speaker set 30 from the voice signals (the voice signal of the seat 41, the voice signal of the seat 42, the voice signal of the seat 43, and the voice signal of the seat 44).

As the echo canceller, the MC/EC 113 cancels an echo component, which is a signal generated by re-inputting of a voice or the like of a speaking person output from the speaker set 30, from the voice signal of the speaking person directly input to each of the microphones (the first microphone 21, the second microphone 22, the third microphone 23, and the fourth microphone 24). As the echo canceller, for example, the MC/EC 113 samples a voice signal immediately before being output from the speaker set 30, and cancels the echo component by performing comparison while shifting a phase.

The CTC 114 cancels cross-talk between signal transmission paths by canceling the voice signal transmitted by another signal transmission path among the signal transmission paths through which the respective voice signals (the voice signal of the seat 41, voice signal of the seat 42, voice signal of the seat 43, and voice signal of the seat 44) are transmitted.

Each of the separated voice signals (the voice signal of the seat 41, the voice signal of the seat 42, the voice signal of the seat 43, and the voice signal of the seat 44) after the cross-talk cancellation by the CTC 114 is output to the control unit 13 via the ES/NS/CTS 12.

The SR 15 performs speaking person recognition on each of the voice signals (the voice signal of the seat 41, the voice signal of the seat 42, the voice signal of the seat 43, and the voice signal of the seat 44) and provides a speaking person recognition result of each of the voice signals (the voice signal of the seat 41, the voice signal of the seat 42, the voice signal of the seat 43, and the voice signal of the seat 44) to the control unit 13. As an example, the SR 15 acquires each of the separated voice signals (the voice signal of the seat 41, the voice signal of the seat 42, the voice signal of the seat 43, and the voice signal of the seat 44) after the cross-talk cancellation by the CTC 114 and performs speaking person recognition on each voice signal. The SR 15 may acquire a signal output from the ES/NS/CTS 12 and perform the speaking person recognition. In addition, the SR 15 may perform the speaking person recognition by using a microphone of each seat in another system. As the SR 15, one provided in another in-vehicle device may be used.

Each speaking person recognition result provided by the SR 15 to the control unit 13 is information in which identification information (corresponding to the seat of the utterer of the voice signal) corresponding to a communication channel (CH) of an acquisition destination of the voice signal for which the SR 15 has performed the speaking person recognition is associated with utterer information corresponding to the utterer recognized by the speaking person recognition. The above-described utterer information includes, as an example, attribute information that indicates a relationship between registrants, for example, registration information such as a family, an adult, or a child.

The ES/NS/CTS 12 is a suppressor corresponding to echo, noise, or cross-talk. The ES/NS/CTS 12 processes unnecessary components that cannot be processed by the voice signal input and processing unit 11. For example, as the echo suppressor, the ES/NS/CTS 12 compares a signal intensity (volume) between the voice signal after the cross-talk cancellation and the voice signal immediately before being output from the speaker set 30, and attenuates the voice signal having a lower signal intensity (volume). As the noise suppressor, the ES/NS/CTS 12 attenuates a noise component such as road noise or wind noise. As the cross-talk suppressor, the ES/NS/CTS 12 attenuates a cross-talk component from other seats.

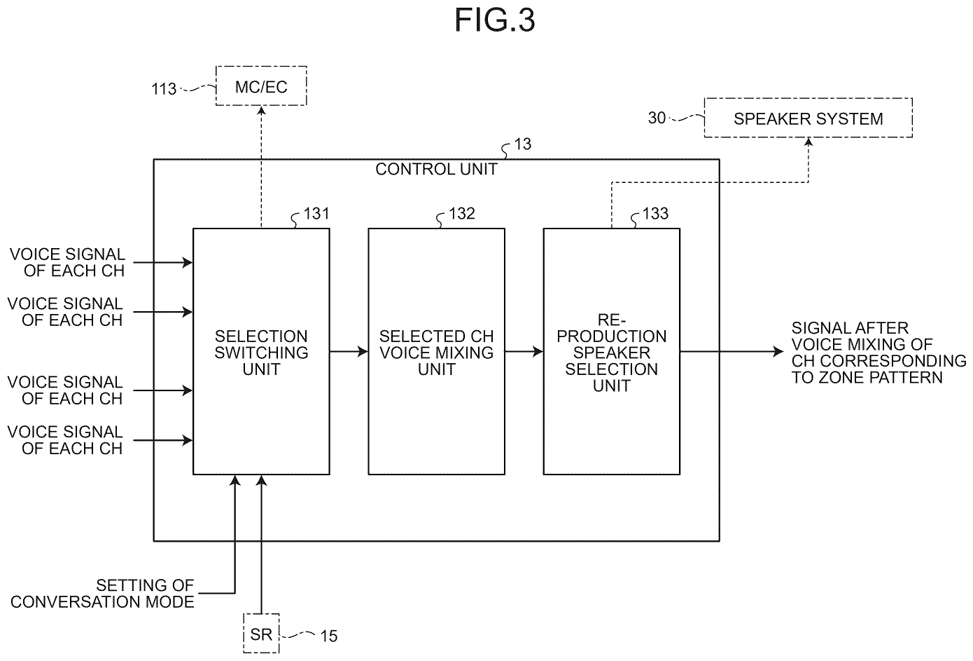

FIG. 3 is a diagram illustrating an example of a configuration of functional blocks for switching a call by the control unit 13. As illustrated in FIG. 3, the control unit 13 includes a selection switching unit 131, a selected CH voice mixing unit 132, and a reproduction speaker selection unit 133.

The selection switching unit 131 selects a channel (CH) of the seat corresponding to setting of a conversation mode based on channel (CH) information of each seat and the utterer information of the passenger of each seat included in the speaking person recognition result of the SR 15. The voice signal of each CH corresponds to each of the voice signals (each of the voice signal of the seat 41, the voice signal of the seat 42, the voice signal of the seat 43, and the voice signal of the seat 44) output from the ES/NS/CTS 12.

In addition, in a case where a combination of CHs to be selected is changed, the selection switching unit 131 resets the MC/EC 113 in order to prevent abnormal noise when switching the call area. When the selection change described above is made, the call area is changed. When the call area is switched, both a combination of the CHs for acquiring the voice signals and a combination of the speakers to be turned on are changed, and an echo path in a vehicle interior space is changed. Therefore, voice quality at the time of switching is stabilized by resetting the MC/EC 113. The call area is an arbitrary area in the vehicle interior space where a call can be made at a seat by one person or each of a plurality of persons to be selected as a call target person, and the call area is also changed according to an arrangement of the seats and a combination of the seats selected based on the selection change described above.

The selected CH voice mixing unit 132 mixes and outputs the voice signals of the selected CHs among the voice signal of the seat 41, the voice signal of the seat 42, the voice signal of the seat 43, and the voice signal of the seat 44. In a case where only one CH is selected, only the voice signal of the selected CH is output.

The reproduction speaker selection unit 133 selects the speaker of the seat corresponding to the selected CH as a reproduction speaker, turns on the reproduction speaker, and turns off the other speakers. A signal output from the selected CH voice mixing unit 132 is output to both the reproduction speaker after switching and the transmission unit 14.

The transmission unit 14 transmits the signal (the voice signal of the seat 41, the voice signal of the seat 42, the voice signal of the seat 43, the voice signal of the seat 44, or a mix signal obtained by mixing a plurality of voice signals) output from the selected CH voice mixing unit 132 to the call partner.

A voice of the call partner is reproduced from the speaker selected by the control unit 13.

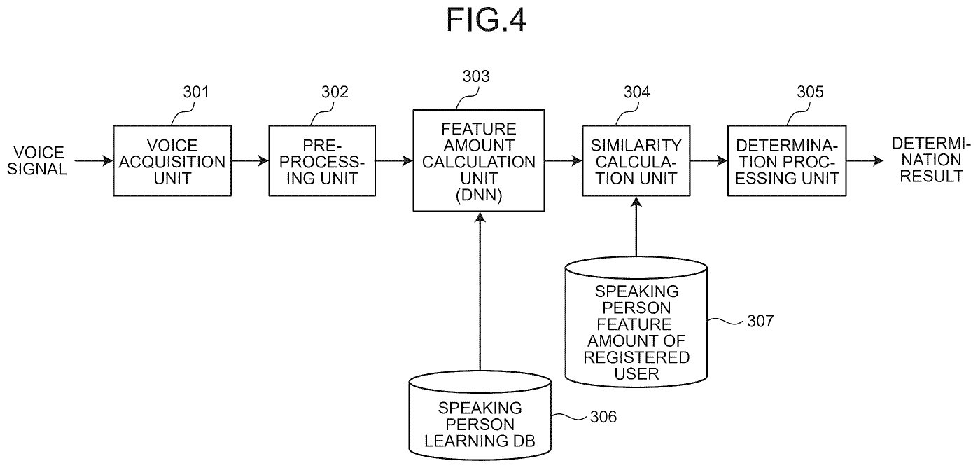

FIG. 4 is a diagram illustrating an example of functional blocks of the SR 15 that performs the speaking person recognition. For example, the SR 15 acquires each of the voice signals (the voice signal of the seat 41, the voice signal of the seat 42, the voice signal of the seat 43, and the voice signal of the seat 44) separated by the CTC 114 (see FIG. 2) by selecting the CH, and recognizes the speaking person for each of the voice signals (the voice signal of the seat 41, the voice signal of the seat 42, the voice signal of the seat 43, and the voice signal of the seat 44) acquired by selecting the CH. Since a procedure of speaking person recognition processing for each of the voice signals (the voice signal of the seat 41, the voice signal of the seat 42, the voice signal of the seat 43, and the voice signal of the seat 44) is the same, the procedure of the speaking person recognition processing will be described in detail using one voice signal as an example.

The functional blocks for the speaking person recognition illustrated in FIG. 4 include a voice acquisition unit 301, a preprocessing unit 302, a feature amount calculation unit 303, a similarity calculation unit 304, and a determination processing unit 305.

As illustrated in FIG. 4, the voice acquisition unit 301 acquires the voice signal. Subsequently, the preprocessing unit 302 executes preprocessing such as calculation of a voice activity segment and restriction of a passband of a signal of the voice activity segment.

Subsequently, the feature amount calculation unit 303 calculates a feature amount of the voice signal in the voice activity segment after the preprocessing is executed. As an example, the feature amount calculation unit 303 calculates a speaking person feature amount of the voice signal by applying a speaking person feature amount deep neural network (DNN). The DNN is a trained model generated based on voice data of an enormous number of speaking persons for learning in a speaking person learning DB 306. The voice signal of the voice activity segment is input to the speaking person feature amount DNN, and the feature amount is obtained from an output layer of the speaking person feature amount DNN. The feature amount indicates a voice feature of the speaking person, and thus is referred to as a speaking person feature amount.

Subsequently, the similarity calculation unit 304 calculates a similarity between the speaking person feature amount obtained by the feature amount calculation unit 303 and a speaking person feature amount of a registered user. A speaking person whose speaking person feature amount has been registered in advance is referred to as the registered user. The speaking person feature amount of the registered user is included in data 307.

Subsequently, the determination processing unit 305 outputs a determination result indicating that the registered user whose similarity satisfies a predetermined condition is the speaking person based on the similarity to the speaking person feature amount of each registered user. In a case where none of the similarities satisfies the predetermined condition, a determination result indicating that the speaking person is an unregistered speaking person is output.

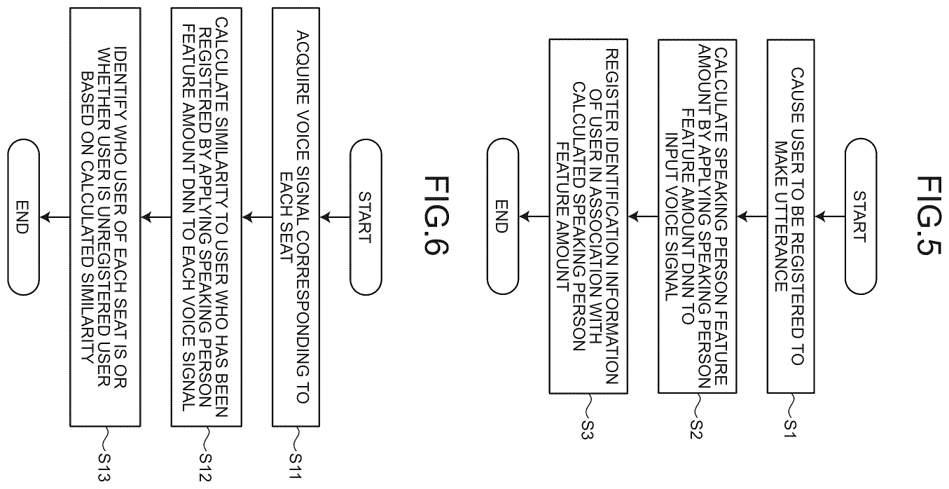

FIG. 5 is a flowchart illustrating an example of speaking person registration processing in the in-vehicle device 10. When the SR 15 of the in-vehicle device 10 is switched to a speaking person registration mode, the registration processing is started. The switching to the speaking person registration mode may be performed manually or automatically. As an example, the switching to the speaking person registration mode is performed when the user operates a speaking person registration button of the in-vehicle device 10.

As illustrated in FIG. 5, the in-vehicle device 10 first causes the user to be registered to make an utterance (Step S1). For example, the in-vehicle device 10 outputs a message prompting the user to be registered to make an utterance by voice or display of a UI screen via a speaker or a display provided therein, and waits for voice input from the microphone for a certain period of time. The microphone for inputting the voice may be manually selectable, or may be automatically selectable by detecting the microphone corresponding to the seat where the utterance has been made.

Subsequently, the SR 15 acquires the voice signal from the selected microphone for a predetermined period of time and executes preprocessing, and calculates the speaking person feature amount by applying the speaking person feature amount DNN to the voice signal after the preprocessing (Step S2).

Subsequently, the SR 15 registers the utterer information in the data 307 in association with the calculated speaking person feature amount (Step S3).

FIG. 6 is a flowchart illustrating an example of the speaking person recognition processing executed by the SR 15 of the in-vehicle device 10 in the speaking person recognition mode. This processing is processing for identifying the passenger at each seat. After a power supply of the in-vehicle device 10 is activated, the speaking person recognition mode is automatically or manually set, and the following speaking person recognition processing is started.

First, the SR 15 acquires the voice signal corresponding to each seat (Step S11). The SR 15 acquires the voice signal corresponding to each seat by acquiring the voice signal uttered at the seat from the input signal of the microphone corresponding to the seat.

Subsequently, the SR 15 executes the preprocessing on each voice signal corresponding to each seat, calculates the speaking person feature amount by applying the speaking person feature amount DNN to the voice signal after the preprocessing, and calculates the similarity to the speaking person feature amount of the registered user (Step S12).

Subsequently, the SR 15 determines and identifies which of the registered users the speaking person of each seat is or whether the speaking person of each seat is an unregistered speaking person based on the similarity calculated for each voice signal corresponding to each seat (Step S13).

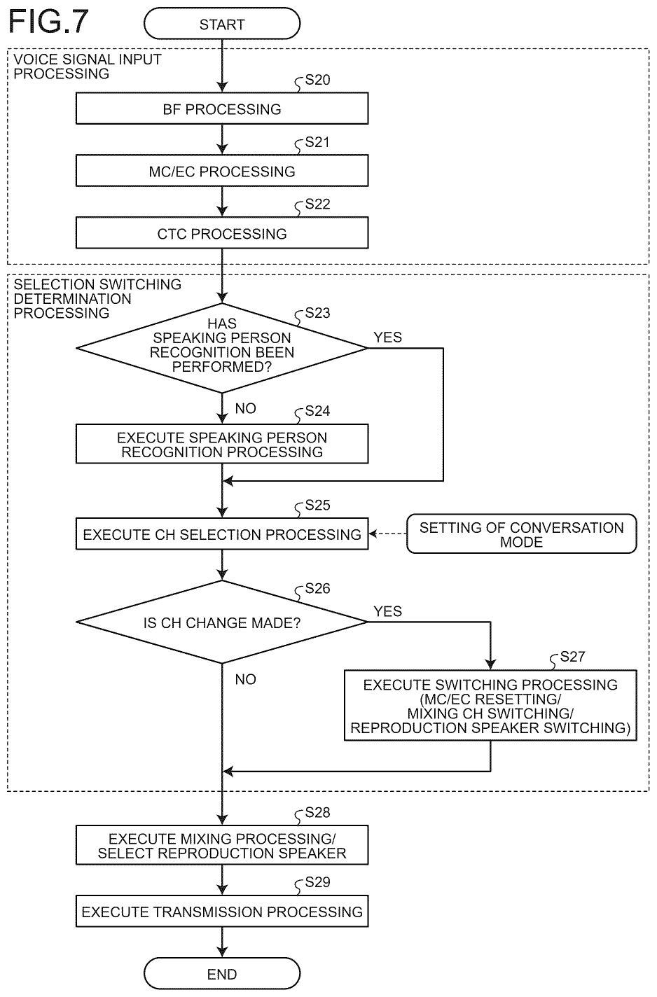

FIG. 7 is a flowchart illustrating an example of control processing in the voice system. This processing is started after the power supply of the in-vehicle device 10 is activated.

First, the voice system executes voice signal input processing in Steps S20 to S22. Specifically, the voice system executes BF processing (beamforming processing) by the first BF 111 and the second BF 112 (Step S20). Subsequently, the voice system executes MC/EC processing (music cancellation processing/echo cancellation processing) by the MC/EC 113 (Step S21). Subsequently, the voice system executes CTC processing (cross-talk cancellation processing) by the CTC 114 (Step S22).

Subsequently, the voice system executes selection switching determination processing in Steps S23 to S27. First, the voice system determines whether or not the speaking person recognition has been performed (Step S23). Specifically, the voice system determines whether or not identification of the passenger of each seat has been performed. Since the speaking person recognition is not performed immediately after activation of the power supply of the in-vehicle device 10 (Step S23: NO), the speaking person recognition processing is executed (Step S24). The speaking person recognition processing may be executed at any time after the activation, but if there is no utterance of the passenger at each seat, identification of the passenger of each seat cannot be completed before the call. Therefore, the in-vehicle device 10 may output a message prompting the passenger to make an utterance by voice or display of the UI screen to complete voice recognition for identifying the passenger of the seat.

After completion of the speaking person recognition, that is, completion of the identification of the passenger of each seat (Step S23: YES), the voice system executes CH selection processing (Step S25). Specifically, the selection switching unit 131 selects the CH of the seat corresponding to the setting of the conversation mode from among the CHs of the voice signals (the voice signal of the seat 41, the voice signal of the seat 42, the voice signal of the seat 43, and the voice signal of the seat 44) output from the ES/NS/CTS 12 based on the utterer information of the seat of the passenger for which the speaking person recognition has been performed.

Subsequently, in a case where a CH change is made (Step S26: YES), the selection switching unit 131 executes switching processing (Step S27). For example, the selection switching unit 131 issues an instruction to perform resetting of the MC/EC 113, switching of the CH for which voice signal mixing is to be performed, and switching of the reproduction speaker. The CH change also corresponds to, for example, a case where the change is made according to selection by the user.

Following a case where the CH change is not made (Step S26: No) or following the execution of the switching processing after the CH change is made (Step S27), the selected CH voice mixing unit 132 executes mixing processing on the voice signal of the selected CH, and the reproduction speaker selection unit 133 selects a designated reproduction speaker (Step S28). In a case where there is a change in the selected CH, switching is performed such that the speaker of the seat corresponding to the selected CH is turned on as the reproduction speaker and the others are turned off.

Then, the transmission unit 14 transmits the mixed voice signal of the selected CH to the call partner (Step S29).

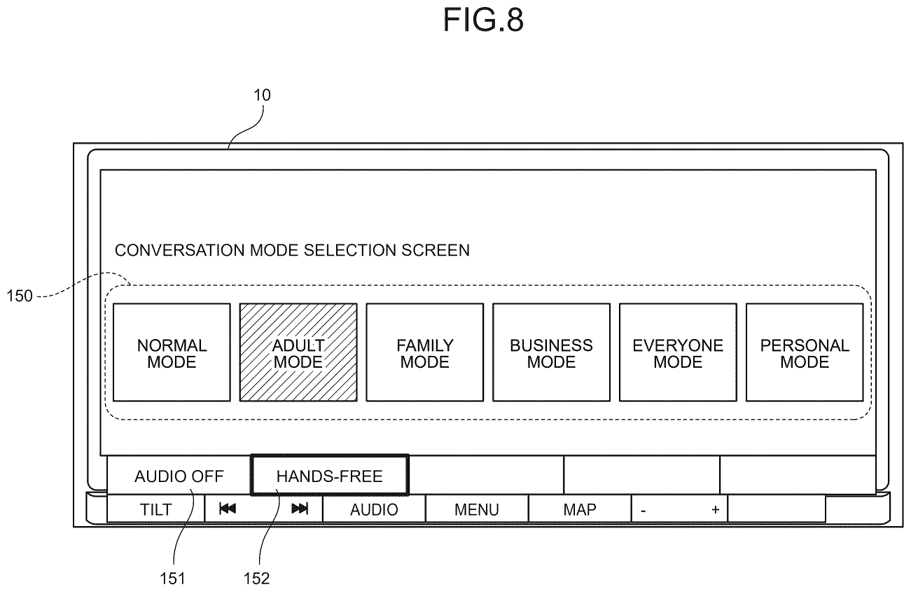

FIG. 8 is a view illustrating an example of a setting unit for the conversation mode. FIG. 8 illustrates a UI screen displayed on the in-vehicle device 10 as an example of the setting unit. An audio on/off button 151, a hands-free setting button 152, and the like are provided in the in-vehicle device 10, and the in-vehicle device 10 can switch on/off of an audio system, on/off of a hands-free mode, and the like.

Selection buttons 150 for different conversation modes are provided in the UI screen illustrated in FIG. 8. The user selects one pattern from the plurality of selection buttons 150 to set the conversation mode.

As an example, the selection buttons 150 indicate a “normal mode”, an “adult mode”, a “family mode”, a “business mode”, an “everyone mode”, and a “personal mode”.

Among them, the “family mode” is a mode in which all the seats whose utterer information associated with each seat according to the speaking person recognition result described above belongs to a family are selected. The “adult mode” is a mode in which all seats belonging to adults among the seats belonging to the family described above are selected. The “business mode” is a mode in which one parent is selected. The “adult mode” may be a mode in which all seats whose utterer information based on the speaking person recognition result described above belongs to adults are selected.

The “normal mode” is a mode in which the driver's seat is selected. The “everyone mode” is a mode in which all the seats at which utterances have been recognized are selected. The “personal mode” is a mode in which only a person who has started a hands-free call by, for example, a voice command in a case of receiving a call or making a call is selected.

As described above, the call area can be automatically switched to a seat of a target person by selecting each conversation mode.

These are examples, and other conversation modes may be appropriately provided according to a configuration between speaking persons, a configuration of the seat, and the like.

Furthermore, the selection of each conversation mode may be performed by a contact operation such as touching a selection screen, or the conversation mode may be selected by recognizing a voice command uttered by the user.

In addition, the in-vehicle device 10 may automatically select a corresponding conversation mode based on information (for example, a telephone number) of the call partner at the start of the hands-free mode and present the selected conversation mode to the user. For example, in the case of a call from a registered family member, the “family mode” is automatically selected.

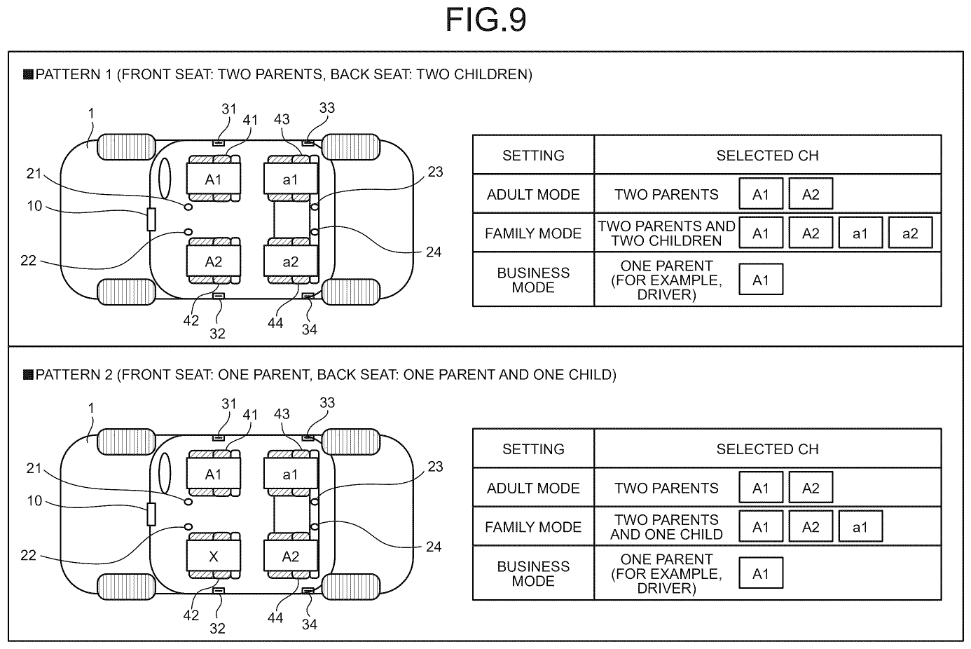

FIG. 9 is a view illustrating an example of a seat pattern selected according to the conversation mode. FIG. 9 illustrates an example of two different passenger patterns as an example.

Pattern 1 as the first pattern is a pattern in which two parents are at the front seats and two children are at the back seats. FIG. 9 illustrates, as an example of an arrangement in the vehicle 1, a state in which a parent A1 is at the seat 41, a parent A2 is at the seat 42, a child al is at the seat 43, and a child a2 is at the seat 44. It is assumed that the speaking person recognition for each seat is completed.

In the table included in FIG. 9, three settings of the “adult mode”, the “family mode”, and the “business mode” are illustrated as an example.

In the example of the passenger pattern shown in Pattern 1, in a case where the “adult mode” is set, the parent A1 and the parent A2 are selected based on the utterer information obtained by the speaking person recognition for each seat. Since the seats of the parent A1 and the parent A2 are known, the CHs of the voice signals of the parent A1 and the parent A2 (the CHs corresponding to the first microphone 21 and the second microphone 22, respectively) are selected, and the respective speakers of the parent A1 and the parent A2 (the first speaker 31 and the second speaker 32) are also selected to be turned on.

Similarly, in a case where the “family mode” is set, the parent A1, the parent A2, the child a1, and the child a2 are selected based on the utterer information obtained by the speaking person recognition for each seat. Since each seat is also known, the CHs of the voice signals of the parent A1, the parent A2, the child a1, and the child a2 (the CHs corresponding to the first microphone 21, the second microphone 22, the third microphone 23, and the fourth microphone 24, respectively) are selected, and the respective speakers of the parent A1, the parent A2, the child a1, and the child a2 (the first speaker 31, the second speaker 32, the third speaker 33, and the fourth speaker 34) are also selected to be turned on.

Similarly, in a case where the “business mode” is set, the parent A1 (driver) is selected based on the utterer information obtained by the speaking person recognition for each seat. Since each seat is also known, the CH of the voice signal of the parent A1 (the CH corresponding to the first microphone 21) is selected, and the speaker of the parent A1 (the first speaker 31) is also selected to be turned on.

Pattern 2 as the second pattern is a pattern in which one parent is at the front seat and one parent and one child are at the back seats. The seat 42 (passenger seat) is assumed to be another person X.

Also in this case, in a case where the “adult mode” is set, similarly, the parent A1 and the parent A2 are selected based on the utterer information obtained by the speaking person recognition for each seat. However, since the seat of the parent A2 is different from that in Pattern 1, the CH corresponding to the fourth microphone 24 is selected as the CH of the voice signal of the parent A2, and the fourth speaker 34 is selected to be turned on as the speaker of the parent A2.

In a case where the “family mode” is set, three persons of the parent A1, the parent A2, and the child a1 are selected. Since the seat 42 (passenger seat) is another person X, the CH corresponding to the second microphone 22 is not selected, and the second speaker 32 is also turned off.

In the present embodiment, an example in which the voice processing device is applied to the in-vehicle device 10 has been described as an example. The in-vehicle device 10 illustrated as an example may be a communication device having a call function, or may be a separate voice processing device used by being communicably connected to a communication device. In addition, a smartphone of the passenger may be paired with the voice processing device to makes a hands-free call.

In addition, the speaking person recognition by the SR 15 may be performed only for a certain period from the start of the engine, and the speaking person recognition for each seat may be completed during the period, or the speaking person recognition by the SR 15 may be constantly performed. In a case where the speaking person recognition is constantly performed, it is possible to detect and add the passenger of the seat at which no utterance has been made during a certain period from the start of the engine. In addition, even after a person gets in or out of the vehicle without stopping the engine while the vehicle is stopped, or even when the passenger moves to another seat while the vehicle is traveling, it is possible to follow the change in arrangement by constantly performing the speaking person recognition. In addition, the conversation mode may be changed after the start of the hands-free call.

Furthermore, the voice processing device may present, to the user, whether or not to change the call area in the case of switching the call area. For example, in the family mode, in a case where a child who has been sleeping until the start of the hands-free call wakes up and makes an utterance during the hands-free call, it is determined that a new utterer is a child of the family, and thus one seat in the family mode is automatically added and the call area is changed. In such a case, the voice processing device may check with the user whether or not to add one seat and expand the call area.

In the present embodiment, the voice processing device uses the plurality of microphones and the plurality of speakers, automatically selects the microphone and the speaker corresponding to each seat according to the set conversation mode, and switches the call area. When the call area of the seat is switched according to the set conversation mode, the echo path in the vehicle interior space is changed, and thus abnormal noise occurs. However, the voice processing device can suppress abnormal noise by resetting the MC/EC 113 or the like. Furthermore, with the voice processing device, it is possible to make a call with favorable voice quality by canceling music and noise.

Further, the voice processing device can recognize the speaking person only with voice even at a position where the face is not shown in a camera. In addition, the voice processing device can recognize the speaking person only with voice even in a case where the camera cannot properly image the speaking person due to low light, or an appearance of the speaking person is different from a registered face image due to glasses, sunglasses, a mask, or the like.

### First Modified Example

In the embodiment, the configuration of the voice system in which the passengers of the respective seats are close to each other has been described as an example. In this case, even when a plurality of speaking persons are selected as speaking persons in the family mode or the like, the voices of the speaking persons directly reach the ears, as a result of which contents uttered by the speaking persons to the microphone can be shared. On the other hand, in the case of a three-row seat vehicle, the passengers of the seats in the first row and the seats in the third row may be selected. In such a case, the seats of the speaking persons are far from each other, and it is difficult for the voices to directly reach the ears due to music, road noise, or the like. Therefore, it is difficult for the speaking persons to directly hear the voices, and it is difficult for the speaking persons to share the contents uttered to the microphone.

Therefore, a configuration in which an in-car communication function is provided for a case where it is difficult for the selected speaking persons to share the contents uttered by the speaking persons to the microphone, such as a case where the seats of the selected speaking persons are far from each other, will be described as a modified example.

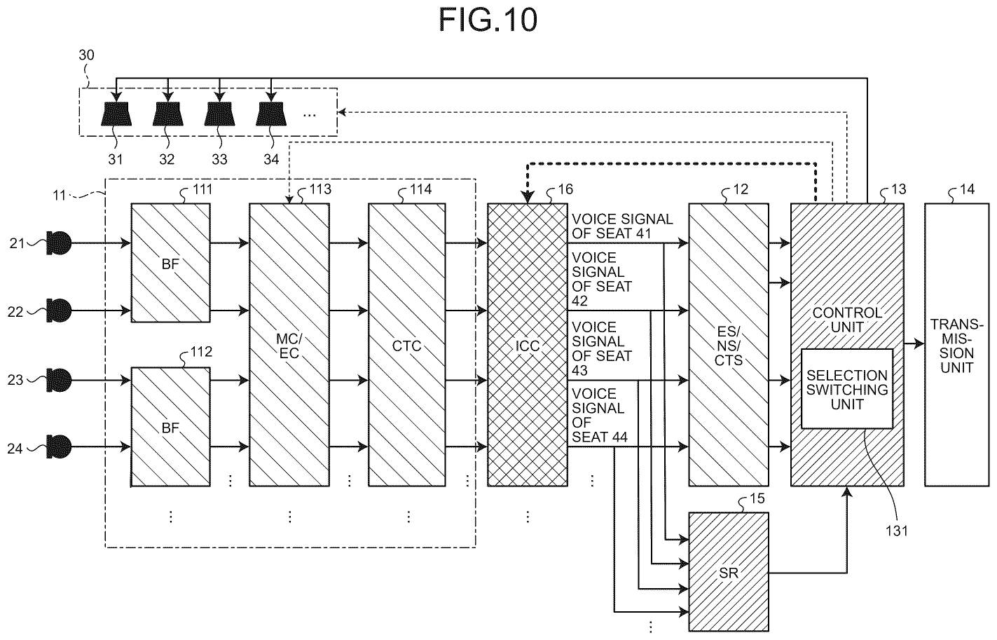

FIG. 10 is a diagram illustrating an example of processing blocks of a voice processing device according to the first modified example of the embodiment. The voice processing blocks illustrated in FIG. 10 include an ICC 16 (as an example of a voice processing unit) in a configuration including microphones and speakers in the third and subsequent rows. In FIG. 10, portions corresponding to the voice processing blocks illustrated in FIG. 2 are denoted by the same reference numerals. A portion corresponding to the voice processing block illustrated in FIG. 2 will not be described because the description is repeated, and an operation of the ICC 16 will be described in detail here.

The ICC 16 is a processing block that performs in-car communication. The ICC 16 is a processing block that executes processing including a voice signal of a target speaking person, and is controlled by a selection switching unit 131 of a control unit 13.

As an example, the selection switching unit 131 turns on the ICC 16 in a case of an arrangement in which voices of selected speaking persons are difficult to directly reach based on an arrangement relationship between seats of the speaking persons. When the ICC 16 is turned on, for example, a voice uttered by an utterer of the front seat to a front microphone is output from a speaker of the back seat, so that an utterer of the back seat can easily hear the voice of the utterer of the front seat. Details of the operation of the ICC 16 are described below. In addition, the selection switching unit 131 may turn off the ICC 16 in a case where there is one selected speaking person or in a case where the selected speaking persons are arranged such that the voices directly reach the selected speaking persons.

The selection switching unit 131 can determine whether or not an arrangement of the speaking persons is an arrangement in which the voices of the speaking persons are difficult to directly reach the speaking persons according to a condition. As an example, the selection switching unit 131 determines that the arrangement of the speaking persons is an arrangement in which the voices of the speaking persons are difficult to directly reach the speaking persons in a case where a distance between seats of at least one pair of two selected speaking persons is equal to or larger than a certain value. Distance data indicating the distance between the respective seats may be stored in the selection switching unit 131.

For example, the selection switching unit 131 determines that the arrangement of the speaking persons is an arrangement in which the voices of the speaking persons are difficult to directly reach the speaking persons in a case where the seat in the first row and the seat in the third row are selected. On the other hand, the selection switching unit 131 determines that the arrangement of the speaking persons is not an arrangement in which the voices of the speaking persons are difficult to directly reach the speaking persons in a case where the seat in the first row and the seat in the second row are selected. In a case where the seat in the first row, the seat in the second row, and the seat in the third row are selected, the selection switching unit 131 determines that the second row does not correspond to the case where the arrangement of the speaking persons is an arrangement in which the voices of the speaking persons are difficult to directly reach the speaking persons, and turns off the ICC 16 for the second row.

In addition, the selection switching unit 131 may turn on the ICC 16 under other conditions. Examples of other conditions include a traveling speed, an open/closed state of a window, a volume of music in the vehicle, a noise level in the vehicle, a road surface condition, weather information, and a volume of a voice of a selected speaking person.

For example, the selection switching unit 131 turns on the ICC 16 when the traveling speed is 100 km or higher. Further, the selection switching unit 131 turns on the ICC 16 when the window is open or the like. In addition, the selection switching unit 131 turns on the ICC 16 when the volume of music in the vehicle is equal to or higher than 30, or the like. Further, the selection switching unit 131 turns on the ICC 16 when the noise level estimated from the microphone in the vehicle is 70 dBA or higher. In addition, the selection switching unit 131 turns on the ICC 16 when the road surface condition of a position where the vehicle travels indicated by position information of the vehicle is bad. Further, the selection switching unit 131 turns on the ICC 16 when the weather information such as a large noise of a rain sound is acquired. Further, the selection switching unit 131 turns on the ICC 16 when the volume of the voice of the selected speaking person is equal to or lower than a threshold to amplify the voice.

Hitherto, some examples of turning on the ICC 16 by the determination performed by the selection switching unit 131 have been described, but the present disclosure is not limited thereto. The user may actively turn on the ICC 16 regardless of the determination performed by the selection switching unit 131.

In the voice processing device according to the first modified example, in a case where a combination of CHs to be selected is changed, a howling path is also changed, and thus, it is desirable to reset the ICC 16 as well as to reset an MC/EC 113.

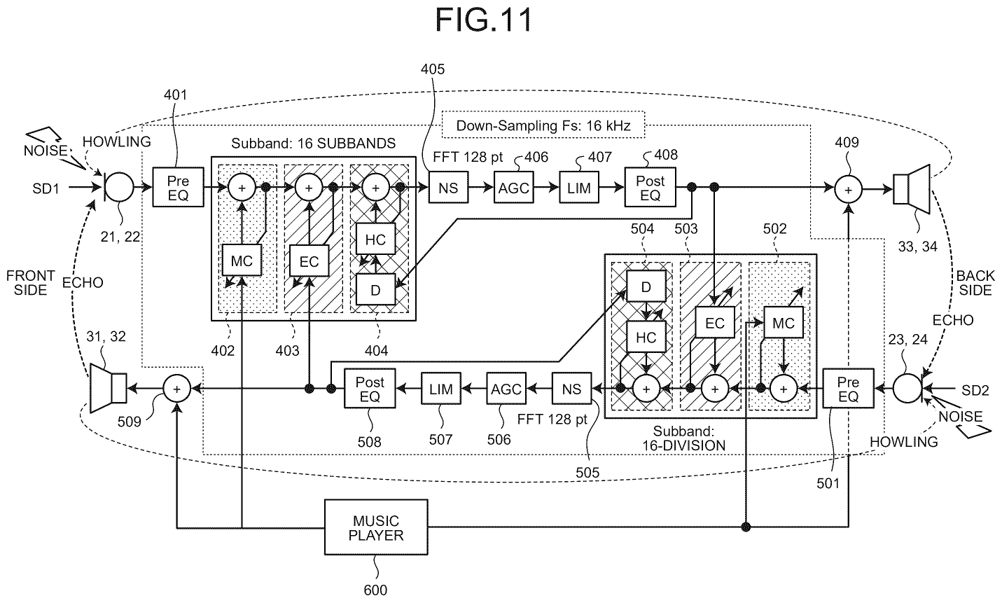

FIG. 11 is a diagram for describing an operation of the ICC 16. Processing blocks illustrated in FIG. 11 illustrate, as an example, processing between two pairs of microphones and speakers positioned at positions distant in back and force from each other. For example, processing between two pairs, a pair of a microphone 21 and a speaker 31 of a front seat and a pair of a microphone 23 and a speaker 33 of a back seat, is illustrated. FIG. 5 also illustrates processing between two pairs, a pair of a microphone 22 and a speaker 32 of a front seat and a pair of a microphone 24 and a speaker 34 of a back seat. Such a relationship is an example for description, and two pairs of seats with other seats may have a similar processing relationship for each seat. The same applies to a case where there are microphones and speakers in the third and subsequent rows.

As an example, in the following description, it is assumed that the speaking person of the front seat makes an utterance to the microphone 21 and the speaking person of the back seat makes an utterance to the back microphone 23.

As illustrated in FIG. 11, an input signal SD1 input from the front microphone 21 is input to a PreEQ 401, and a voice signal from the PreEQ 401 is processed sequentially by a music canceller (MC) 402, an echo canceller (EC) 403, and a howling canceller (HC) 404. The EQ refers to an equalizer. The voice signal is processed by being 16-divided into subbands as an example.

The MC 402 cancels playback music included in the voice signal. In this example, the MC 402 acquires a music playback signal being played back by a music player 600, and cancels the music playback signal from the voice signal to be transmitted.

The EC 403 cancels an echo generated when the voice of the speaking person of the back seat output from the front speaker 31 is input again to the front microphone 21. In this example, the EC 403 acquires the last voice signal output from the front speaker 31, and cancels a signal corresponding to the acquired voice signal from an input signal input from the front microphone 21.

The HC 404 cancels howling caused when a voice signal input to the front microphone 21 is output from the back speaker 33 and then input to the front microphone 21 again. In this example, the HC 404 acquires the last voice signal output from the back speaker 33, and cancels a signal corresponding to the acquired voice signal from the input signal input from the front microphone 21. As a result, it is possible to cancel the voice signal input again from the front microphone 21. Since there is a time difference until the voice signal is input again from the front microphone 21, the acquired voice signal is held by a delay circuit (D) until that timing.

The voice signal is processed sequentially by an NS 405, an AGC 406, an LIM 407, and a PostEQ 408 following the HC 404. Here, the NS refers to noise suppression. The AGC refers to an auto gain controller. The LIM refers to a limiter.

The NS 405 extracts a frequency component from the voice signal by fast Fourier transform (FFT), and attenuates a noise component of noise input from the microphone 21, for example, a noise component such as road noise or wind noise.

Then, the voice signal output from the NS 405 is output via the LIM 407 with a predetermined gain obtained by the AGC 406. Finally, the music playback signal being played back by the music player 600 is mixed with the voice signal output via the PostEQ 408 and output to the speaker 33.

In summary, the turning on of the ICC 16 is implemented by the output of the voice signal input to the front microphone 21 from the back speaker 33 and the operation of the HC 404. When the ICC 16 is turned on, the AGC 406 may be operated.

The same applies to processing between the microphone 23 of the back seat and the speaker 31 of the front seat illustrated in FIG. 11. An input signal SD2 input from the back microphone 23 is input to a PreEQ 501, and a voice signal from the PreEQ 501 is processed sequentially by an MC 502, an EC 503, and an HC 504. The voice signal is similarly processed by being divided into 16 subbands.

The MC 502 similarly cancels playback music included in the voice signal. That is, the MC 502 acquires a music playback signal being played back by the music player 600 and cancels the music playback signal from the voice signal to be transmitted.

The EC 503 cancels an echo generated when the voice signal of a front speaking person output from the back speaker 33 is input again to the back microphone 23. In this example, the EC 503 acquires the last voice signal output from the back speaker 33, and cancels a signal corresponding to the acquired voice signal from an input signal input from the back microphone 23.

The HC 504 cancels howling caused when a voice signal input to the back microphone 23 is output from the front speaker 31 and then input to the back microphone 23 again. In this example, the HC 504 acquires the last voice signal output from the front speaker 31, and cancels a signal corresponding to the acquired voice signal from the input signal input from the back microphone 23. As a result, it is possible to cancel the voice signal input again from the back microphone 23. Since there is a time difference until the voice signal is input again from the back microphone 23, the acquired voice signal is held by the delay circuit (D) until that timing.

The voice signal is processed sequentially by an NS 505, an AGC 506, an LIM 507, and a PostEQ 508 following the HC 504.

The NS 505 extracts a frequency component from the voice signal by fast Fourier transform, and attenuates a noise component of noise input from the microphone 23, for example, a noise component such as road noise or wind sound.

Then, the voice signal output from the NS 505 is output via the LIM 507 with a predetermined gain obtained by the AGC 506. Finally, the music playback signal being played back by the music player 600 is mixed with the voice signal output via the PostEQ 508 and output to the speaker 31.

In summary, the turning on of the ICC 16 is implemented by the output of the voice signal input to the back microphone 23 from the front speaker 31 and the operation of the HC 504. When the ICC 16 is turned on, the AGC 506 may be operated.

As described above, in a case where the ICC 16 is introduced, the voice processing device is configured such that the voice uttered by the utterer of the front seat to the front microphone 21 (or the microphone 22) is output to the speaker 33 (or the speaker 34) of the back seat. Therefore, even in a case where it is difficult for the voices of the utterers to directly reach the utterers, an uttered content can be heard through the speaker. In addition, although howling may occur at this time, an influence thereof can be suppressed by providing the howling canceller.

Furthermore, in a case where the voice of the utterer is small, the voice processing device according to the first modified example can amplify and output the voice by giving a gain by the AGC 406.

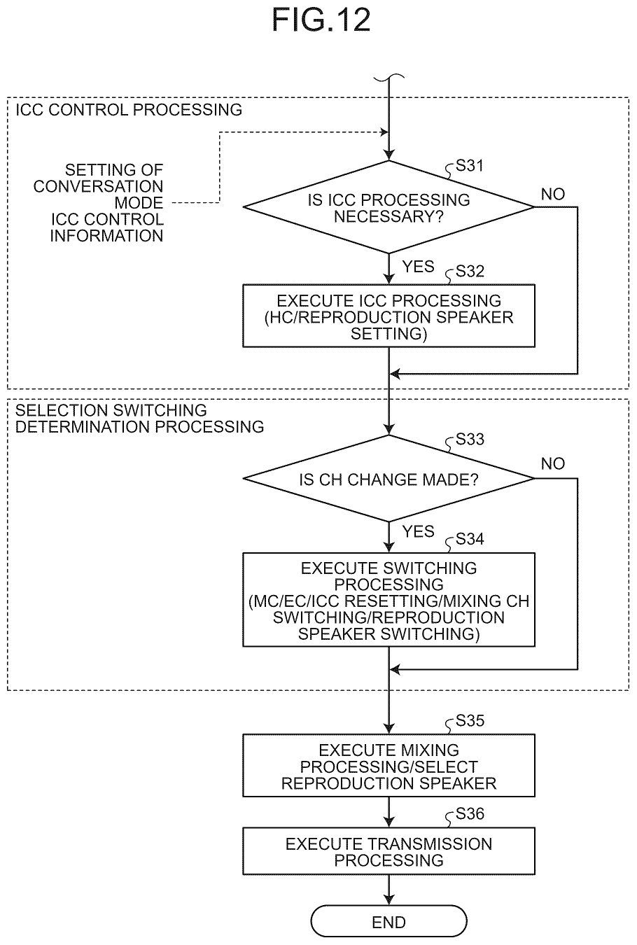

FIG. 12 is a flowchart illustrating an example of control processing in the voice system according to the first modified example of the embodiment. This processing is processing that further includes ICC control processing after Step S26 in the processing illustrated in FIG. 7. Hereinafter, the ICC control processing will be described in detail, and other steps of processing similar to those in FIG. 7 will not be illustrated and described as appropriate.

The ICC control processing corresponds to processing of Step S31 and Step S32 after Step S26. First, in Step S31, the selection switching unit 131 determines whether or not ICC processing is necessary from seats corresponding to setting of a conversation mode or ICC control information. From the seats corresponding to the setting of the conversation mode, it is determined whether or not the ICC processing is necessary based on a distance between the selected seats. From the ICC control information, it is determined whether or not the ICC processing is necessary based on a voice level of an input voice (including an influence of ambient noise and the like).

When it is determined that the ICC processing is necessary (Step S31: YES), the selection switching unit 131 selects the ICC processing, and selects the HC (howling canceller) and a reproduction speaker setting for the ICC processing (Step S32). For example, in a case where the distance between the selected seats is equal to or larger than a certain distance, the HC and the reproduction speaker setting between the seats are selected.

In a case where the selection switching unit 131 determines that the ICC processing is not necessary, NO is selected in Step S31.

Subsequently, the selection switching unit 131 determines whether or a CH change is made (Step S33). In a case where the CH change is made (Step S33: YES), switching processing is executed (Step S34). For example, the selection switching unit 131 issues an instruction to perform resetting of the MC/EC/ICC, switching of the CH for which mixing is to be performed, and switching of the reproduction speaker. The CH change also corresponds to, for example, a case where the change is made according to selection by the user.

Since the subsequent processing of Steps S35 and S36 corresponds to the processing of Steps S8 and S29 illustrated in FIG. 7, a description thereof is omitted here.

### Third Modified Example

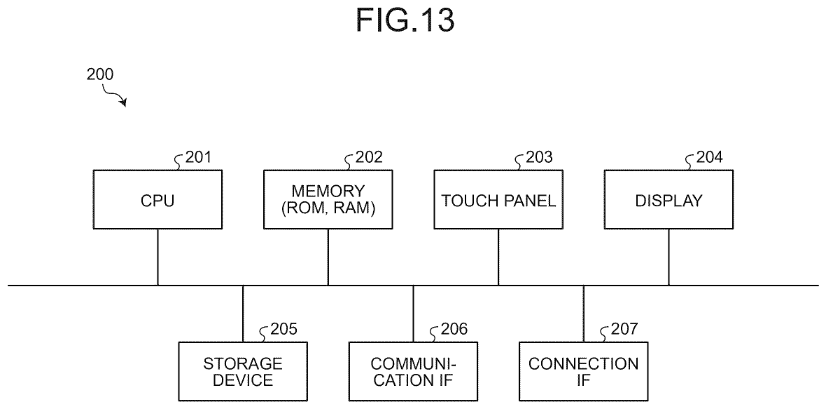

FIG. 13 is a diagram illustrating an example of a configuration of hardware blocks of a voice processing device according to a third modified example of the embodiment.

A voice processing device 200 illustrated in FIG. 13 includes a CPU 201, a memory 202, a touch panel 203, a display 204, a storage device 205, a communication interface (IF) 206, and a connection IF 207. The respective units are connected to one another via a bus.

The CPU 201 is a central processing unit (CPU), and executes a predetermined program stored in the memory 202 to execute control and processing of each unit.

The memory 202 is a read only memory (ROM) or a random access memory (RAM). The memory 202 stores predetermined programs and data. In addition, the CPU 201 has a work area used for processing.

The touch panel 203 is a sensor that detects a touch position on a screen of the display 204.

The display 204 is a display such as a liquid crystal display.

The storage device 205 is a storage such as a hard disk drive (HDD) or a solid state drive (SSD).

The communication IF 206 is a communication interface that communicates with an external device. For example, the communication IF 206 is connected to a predetermined network (such as the Internet) by wireless communication.

The connection IF 207 is an interface for wired or wireless connection with an external device. The connection IF 207 is, for example, an interface such as Bluetooth. The connection IF 207 is communicably connected to an external device such as a microphone or a speaker. In addition to the microphone and the speaker, a camera or the like may be further connected.

The camera includes an imaging device such as a charge coupled device (CCD) or a complementary metal oxide semiconductor (CMOS), and captures an image of an imaging target such as the inside of the vehicle.

The speaker is a speaker set that outputs a predetermined sound (an operation sound, a notification sound, music, or the like) or voice (such as a voice of a call partner or a voice of an utterer in the vehicle) reproduced by the CPU 201, and corresponds to a speaker set 30 including a plurality of speakers such as a first speaker 31, a second speaker 32, a third speaker 33, and a fourth speaker 34.

The microphone is a microphone that converts a voice of each seat into a voice signal and inputs the voice signal, and is a plurality of microphones such as a first microphone 21, a second microphone 22, a third microphone 23, and a fourth microphone 24.

The CPU 201 may execute a predetermined program stored in the memory 202 to implement some or all of the functions of the processing blocks described in the embodiment and the modified examples.

Furthermore, the present disclosure may be implemented including face image recognition using a camera in addition to speaking person recognition using a voice signal.

The present disclosure can be implemented by software, hardware, or software in conjunction with hardware.

The present disclosure may be implemented by a system, an apparatus, a method, an integrated circuit, a computer program, or a recording medium, or may be implemented by any combination of a system, an apparatus, a method, an integrated circuit, a computer program, and a recording medium. A program product is a computer-readable medium on which a computer program is recorded.

In addition, a program in which some procedures or all procedures are recorded can be provided by being recorded in a recording medium or can be stored in a ROM and provided as an information processing apparatus implemented by a computer, or the program can be downloaded via a network and executed by a computer. A CPU of the computer reads and executes the program to execute processing.

According to the present disclosure, it is possible to set a call area of an utterer corresponding to a conversation mode.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Supplementary Note

Aspects of the present disclosure are, for example, as follows.

### Item 1

A voice processing device including:
a voice signal input and processing unit that processes voice signals input from a plurality of voice signal input units;
a voice recognition unit that recognizes voices of utterers each present in corresponding one of areas based on the voice signals processed by the voice signal input and processing unit and associates utterer information with the areas; and
a selection switching unit that selectively switches to a call area corresponding to a setting of a conversation mode based on the utterer information, in which
the selection switching unit selects the call area according to selection of a voice signal transmitted from the voice signal input and processing unit and selection of a voice signal output unit to be made output the voice signal from among a plurality of voice signal output units.

### Item 2

The voice processing device according to Item 1, in which
the voice signal input and processing unit includes an echo canceller that cancels an echo component generated by re-inputting of the voice signal output from the voice signal output unit through the voice signal input unit, and
the selection switching unit resets the echo canceller in a case where the selection of the voice signal output unit is changed.

### Item 3

The voice processing device according to Item 1 or 2, in which
in a case where a voice of a new utterer is recognized based on the voice signal processed by the voice signal input and processing unit, the voice recognition unit associates utterer information corresponding to the new utterer with an area corresponding to the new utterer, and
in a case where the utterer information of the new utterer is added during a call in the set conversation mode, and the utterer information of the new utterer corresponds to the set conversation mode, the selection switching unit switches the call area by including, in the selections, the voice signal transmitted from the voice signal input and processing unit and the voice signal output unit, which correspond to the new utterer.

### Item 4

The voice processing device according to any one of Items 1 to 3, further including
a voice processing unit that outputs a voice signal input to a first voice signal input unit that is the voice signal input unit corresponding to a first utterer to a second voice signal output unit that is the voice signal output unit corresponding to a second utterer, and outputs a voice signal input to a second voice signal input unit that is the voice signal input unit corresponding to the second utterer to a first voice signal output unit that is the voice signal output unit corresponding to the first utterer.

### Item 5

The voice processing device according to any one of Items 1 to 4, in which
the voice processing unit is selected in a case where a distance between an area of the first utterer and an area of the second utterer is equal to or larger than a certain value.

### Item 6

The voice processing device according to any one of Items 1 to 5, in which
the voice processing unit is selected in a case where a state in which voices of the first utterer and the second utterer are hard to hear by one another is detected.

### Item 7

The voice processing device according to any one of Items 1 to 6, in which
the voice acquisition unit is selected in a case where a magnitude of noise estimated from the voice signal input unit is equal to or larger than a certain value.

### Item 8

The voice processing device according to any one of Items 1 to 7, further including
a setting unit that sets the conversation mode from among a plurality of patterns of conversation modes.

### Item 9

The voice processing device according to any one of Items 1 to 8, in which
the utterer information includes attribute information indicating a relationship between utterers, and
the voice signal input unit and the voice signal output unit corresponding to an area of an utterer having the attribute information corresponding to the conversation mode having been set are selected.

### Item 10

The voice processing device according to any one of Items 1 to 9, further including
a transmission unit that transmits a signal obtained by mixing the voice signals from the one or more voice signal input units selected by the selection switching unit to a call partner.

### Item 11

The voice processing device according to any one of Items 1 to 7, in which
the voice recognition unit associates utterer information of a registered user with an area corresponding to the voice signal input unit to which voice information corresponding to voice information of the registered user is input.

### Item 12

A voice processing method of a voice system including a plurality of voice signal input units and a plurality of voice signal output units, the voice processing method including:
a step of processing voice signals input from the plurality of voice signal input units;
a step of recognizing voices of utterers each present in corresponding one of areas based on the voice signals having been processed and associating utterer information with the areas; and
a step of switching to a call area corresponding to setting of a conversation mode by performing selection of a voice signal of the voice signals transmitted from the plurality of voice signal input units and selection of a voice signal output unit to be made output from among the plurality of voice signal output units, based on the utterer information.

### Item 13

A program for causing a computer to which a plurality of voice signal input units and a plurality of voice signal output units are communicably connected, to function as:
a voice signal input and processing unit that processes voice signals input from a plurality of voice signal input units;
a voice recognition unit that recognizes voices of utterers each present in corresponding one of areas based on the voice signals processed by the voice signal input and processing unit and associates utterer information with the areas; and
a selection switching unit that selectively switches to a call area corresponding to a setting of a conversation mode based on the utterer information, in which
the selection switching unit selects the call area according to selection of a voice signal transmitted from the voice signal input and processing unit and selection of a voice signal output unit to be made output the voice signal from among a plurality of voice signal output units.

What is claimed is:

1. A voice processing device comprising:
a memory in which a program is stored; and
a processor coupled to the memory and configured to perform processing by executing the program, the processing including:
processing voice signals input from a plurality of microphones;
recognizing voices of utterers each present in corresponding one of areas, based on the voice signals;
associating area information of each of the areas with utterer information of corresponding one of the utterers whose voice is recognized in corresponding one of the areas; and
selectively switching a call area to a call area corresponding to a setting of a conversation mode, based on the utterer information, wherein
in the selectively switching, the call area is selected by selection of a voice signal from among the voice signals and selection of a speaker that outputs the voice signal from among a plurality of speakers.

2. The voice processing device according to claim 1, wherein
the processing includes:
canceling, by an echo canceller, an echo component generated by re-inputting of the voice signal output from the speaker through at least one of the plurality of microphones; and
resetting the echo canceller in a case where the selection of the speaker is changed.

3. The voice processing device according to claim 1, wherein
the processing includes:
associating utterer information of a new utterer with area information corresponding to an area where the new utterer is present in a case where a voice of the new utterer is recognized based on the voice signals; and
switching the call area by further including, in the selections, a voice signal of a microphone and a speaker corresponding to the area where the new utterer is present, in a case where the utterer information of the new utterer is added during a call in the conversation mode having been set, and the utterer information of the new utterer corresponds to the conversation mode having been set.

4. The voice processing device according to claim 1, wherein
the plurality of microphones include a first microphone corresponding to a first utterer and a second microphone corresponding to a second utterer,
the plurality of speakers include a first speaker corresponding to the first utterer and a second speaker corresponding to the second utterer, and
the processing further includes additional processing of outputting a voice signal input to the first microphone to the second speaker and outputting a voice signal input to the second microphone to the first speaker.

5. The voice processing device according to claim 4, wherein
the additional processing is selected in a case where any one of conditions is satisfied, the conditions including a condition that a distance between an area of the first utterer and an area of the second utterer is equal to or larger than a certain value, a condition that a state in which voices of the first utterer and the second utterer are hard to hear by one another is detected, and a condition that a magnitude of noise included in the voice signal input through the microphone is equal to or larger than a certain value.

6. The voice processing device according to claim 1, wherein
the processing further includes setting the conversation mode from among a plurality of patterns of conversation modes.

7. The voice processing device according to claim 1, wherein
the processing includes transmitting a voice signal from at least one of the plurality of microphones to a call partner.

8. The voice processing device according to claim 1, wherein
the processing includes associating, when voice information corresponding to voice information of a registered user is input, area information of an area corresponding to a microphone to which the voice information is input with utterer information of the registered user.

9. A voice processing method executed by a voice system, the voice processing method comprising:
processing voice signals input from a plurality of microphones;
recognizing voices of utterers each present in corresponding one of area, based on the voice signals;
associating area information of each of the areas with utterer information of corresponding one of the utterers whose voice is recognized in corresponding one of the areas; and
switching to a call area corresponding to a setting of a conversation mode by performing selection of a voice signal from among the voice signals transmitted from the plurality of microphones and selection of a speaker to be made output the voice signal from among a plurality of speakers based on the utterer information.

10. A non-transitory computer-readable storage medium storing program instructions for causing a computer to execute processing including:
processing voice signals input from a plurality of microphones;
recognizing voices of utterers each present in corresponding one of areas, based on the voice signals;
associating area information of each of the areas with utterer information of corresponding one of the utterers whose voice is recognized in corresponding one of the areas; and
selectively switching a call area to a call area corresponding to a setting of a conversation mode, based on the utterer information, wherein
in the selectively switching, the call area is selected by selection of a voice signal from among the voice signals and selection of a speaker that outputs the voice signal from among a plurality of speakers.
